(19) United States
(12) Patent Application Publication
(10) Pub. No.: US 2003/0186597 A1
(43) Pub. Date: Oct. 2, 2003

(54) Connector terminal

(76) Inventors: Takeshi Suzuki, Aizuwakamatsu-shi (JP); Shinei Satoh, Aizuwakamatsu-shi (JP); Tadao Sakakibara, Aizuwakamatsu-shi (JP); Akihito Mori, Aizuwakamatsu-shi (JP)

Correspondence Address: HARNESS, DICKEY & PIERCE, P.L.C., P.O. BOX 828, BLOOMFIELD HILLS, MI, 48303, US

(21) Appl. No.: 10/385,341

(22) Filed: Mar. 10, 2003

(30) Foreign Application Priority Data
Mar. 25, 2002 (JP) 2002-084392
May 9, 2002 (JP) 2002-134387

(51) Int. Cl. H01R 9/24

(52) U.S. Cl. 439/886

(57) ABSTRACT

The connector terminal of the present invention is a connector terminal fabricated with a plated Cu alloy thin plate and is provided with a pair of mutually engaging male terminal 1 and female terminal 2; wherein, in a mutually sliding portion of the male terminal 1 and the female terminal 2, the Vickers hardness of one of the terminals is within the range of 60-700 HV, the Vickers hardness of the other terminal is within the range of 20-150 HV, and the difference between the Vickers hardness values of both is 15 HV or more. As a result, together with having stable contact resistance, both low insertion and removal force as well as superior heat resistance can be obtained.

### BACKGROUND OF THE INVENTION

1. Technical Field

The present invention relates to a connector terminal produced with a metal thin plate in which a pure metal or alloy is finishing plated, and is used for the connector of an automobile and so forth.

2. Background Art

The connector terminals of electrical wiring connectors and so forth typically used in automobiles and the like are fabricated by performing press forming, stamping or bending on a Cu (copper) alloy thin plate, etc. In this case, in order to obtain satisfactory electrical connection characteristics and so forth of the resulting terminal, a metal thin plate is frequently used that has been subjected to pure metal or alloy plating, and particularly Sn (tin) plating or Sn alloy plating. These connector terminals are composed with mutually engaging male and female terminals formed from the metal thin plate.

However, technology relating to the connectors and other connector terminals still has the problems described below.

In recent years, the number of circuits employed in electrical and electronic circuit components has increased accompanying greater functional diversity, the connectors that supply these circuits have an increasingly large number of pins, and the demand for multi-pin connectors is growing. On automobile assembly lines for example, although manual connector installation processes are required, accompanying the growing number of pins, the increase in insertion force is causing fatigue among workers, thereby resulting in a need to reduce that fatigue. Consequently, there is a need for multi-pin connectors requiring less force during insertion and removal.

Moreover, although multi-pin connectors are used in environments subject to high temperatures and vibrations as in locations around automobile engines, there is also a need for connectors that do not exhibit an increase in contact resistance even when exposed to high temperatures for long periods of time, do not exhibit changes in holding strength, and ensure stable installation that prevents them from being disconnected due to vibrations from the engine and so forth.

In the case of terminals composed of the Sn-plated Cu alloy thin plate of the prior art, since the surface layers of the male terminal and female terminal are mutually similar, comparatively soft Sn-plating layers, the sliding of the terminals is not very good when coupling the connector and so forth, thereby requiring considerable insertion and removal force. In addition, when exposed to high temperatures such as those around an engine, the Sn plating layer and Cu alloy of the base material mutually diffuse heat, making the surface status susceptible to changes over time, while also resulting in the risk of fluctuations in contact resistance and holding strength.

### SUMMARY OF THE INVENTION

In consideration of the problems, the object of the present invention is to provide a connector terminal having stable contact resistance, low insertion and removal force and superior heat resistance.

In this connector terminal, in its sliding portion, since the Vickers hardness of one of the terminals is within the range of 60-700 HV, the Vickers hardness of the other terminal is within the range of 20-150 HV, and the difference between the Vickers hardness values of both is 15 HV or more, together with obtaining the effect of reducing insertion force (insertion and removal force), contact superior is superior and the load during manual insertion and removal is less as compared with the case of both having the same degree of hardness.

Namely, although “scraping” occurs in the sliding portions of both terminals in the process of inserting the male terminal into the female terminal, if the hardness of the plated surfaces of both terminals have the same degree of softness, deformation resistance increases and insertion force becomes larger. On the other hand, in the case the hardness of the surface plating of both terminals have the same degree of hardness as well, resistance to scraping increases and insertion force again becomes larger. In addition, in the case there is a difference in the hardness values of the plated surfaces of both terminals, the softer plated surface is scraped easily and insertion force becomes smaller. In this case, the effect of reducing insertion force is obtained in the case the difference between the Vickers hardness values of both terminals is 15 or more.

In addition, the reason for making the Vickers hardness of one terminal within the range of 60-700 HV is that, if the hardness is less than 60 HV, deformation resistance during terminal insertion increases even if the difference between the hardness values of both terminals is 15 HV or more, thereby making it difficult to obtain a desirable insertion force, while if the hardness exceeds 700 HV, cases arise in which the insertion force becomes too small, which is undesirable from the viewpoint of contact stability.

In addition, the reason for making the Vickers hardness of the other terminal within the range of 20-150 HV is that, if the hardness is less than 20 HV, the terminal becomes excessively soft, and deformation resistance becomes excessively large with respect to the clearance during insertion, while if the hardness exceeds 150 HV, it becomes difficult to demonstrate the effects resulting from the plated surface being soft.

In the present invention and the present description, Vickers hardness HV is the value at a load of 98.07×10⁻³ newtons (10 g).

In the connector terminal of the present invention, in a mutually sliding portion of the male terminal and the female terminal, it is preferable that the Vickers hardness of one of the terminals is within the range of 80-300 HV, the Vickers hardness of the other terminal is within the range of 40-150 HV, and the difference between the Vickers hardness values of both is 20 HV or more. Namely, in this connector terminal, since the difference between the Vickers hardness values of both terminals is 20 HV or more, even greater insertion force reduction effects can be obtained.

In the connector terminal of the present invention, in a mutually sliding portion of the male terminal and the female terminal, it is preferable that the Vickers hardness of one of the terminals is within the range of 100-250 HV, the Vickers hardness of the other terminal is within the range of 40-130 HV, and the difference between the Vickers hardness values of both is 30 HV or more. Namely, in this connector terminal, since the difference between the Vickers hardness values of both terminals is 30 HV or more, even greater insertion force reduction effects can be remarkably obtained.

Moreover, in the connector terminal of the present invention, in a mutually sliding portion of the male terminal and the female terminal, it is preferable that the Vickers hardness of one of the terminals is within the range of 120-250 HV, the Vickers hardness of the other terminal is within the range of 40-1 1 0 HV, and the difference between the Vickers hardness values of both is 50 HV or more. Namely, in this connector terminal, since the difference between the Vickers hardness values of both terminals is 50 HV or more, extremely large insertion force reduction effects can be obtained.

In the connector terminal of the present invention, it is preferable that the terminal having the higher Vickers hardness is the male terminal, while the terminal having the lower Vickers hardness is the female terminal. Namely, since the terminal having the higher Vickers hardness is the male terminal and the terminal having the lower Vickers hardness is the female terminal in this connector terminal, insertion force reduction effects are greater. Namely, in contrast to the male terminal normally having a flat shape to facilitate insertion, the one or both of the inner upper and lower surfaces of the female terminal is bent, and has a shape that gives it the role of a spring. Consequently, in contrast to there being many cases in which the male terminal is produced by stamping out directly from a plated flat plate, since there are many cases in which the female terminal is produced by bending, the hardness of the plating material of the female terminal is preferably lower than that of the male terminal with respect to ease of forming. In the case of performing severe bending in the production process in order to accommodate increasingly smaller sizes in recent years in particular, the present invention is preferable because it has a female terminal that is formed easily.

In the connector terminal of the present invention, at least one of the male terminal and the female terminal is fabricated with a metal thin plate in which the surface of a base material of a Cu alloy is subjected to plating treatment containing one type or two or more types of metals selected from the group consisting of Sn, Cu, Ag, Ni, Pb, Zn, P, B, Cr, Mn, Fe, Co, Pd, Pt, Ti, Zr, Hf, V, Nb, Ta, Mo, W, In, C, S, Au, Al, Si, Sb, Bi and Te.

In this connector terminal, since at least one of the male terminal and the female terminal is fabricated with a metal thin plate in which the surface of a base material of a Cu alloy is subjected to plating treatment containing one type or two or more types of metals selected from the group, the Cu alloy base material and the selected metal are partially formed into an alloy, making it easy to harden the plated surface to a prescribed hardness.

In the connector terminal of the present invention, the plating treatment is Sn alloy plating treatment in which the remainder other than the selected one type or two or more types of metals is comprised of Sn. Namely, in this connector terminal, since the plating treatment is Sn alloy plating treatment in which the remainder other than the selected one type or two or more types of metals is comprised of Sn, hardness adjustment of the plated surface can be controlled more easily by adding the selected metal to Sn.

Moreover, in the connector terminal of the present invention, at least one of the male terminal and the female terminal contains 0.01-75% by mass of the selected one type or two or more types of metals. Namely, in this connector terminal, since at least one of the male terminal and female terminal contains 0.01-75% by mass of the selected one type or two or more types of metals, hardening treatment of the plated surface becomes easier, and suitable hardness, electrical resistance and contact resistance of the plated surface can be obtained. This is because, if the added amount of the selected one type or two or more types of metals is less than 0.01% by mass, the action that hardens the plated surface to a prescribed hardness is inadequate, while if the added amount exceeds 75% by mass, together with the electrical resistance of the Sn alloy plating itself becoming high relative to the required level for practical use, the contact resistance and so forth also increases. In addition, in the case the added amount exceeds 75% by mass, together with poor formability, there is also the problem of decreased corrosion resistance.

In the connector terminal of the present invention, at least one of the male terminal and the female terminal may be fabricated with a Cu alloy thin plate subjected to Cu—Sn alloy plating treatment containing 0.1-10% by mass of Cu and in which the remainder is comprised of Sn and unavoidable impurities. Namely, in this connector terminal, since at least one of the male terminal and female terminal is fabricated with a Cu alloy thin plate subjected to Cu—Sn alloy plating treatment containing 0.1-10% by mass of Cu and in which the remainder is comprised of Sn and unavoidable impurities, surface hardening treatment is easy. If the Cu content is less than 0.1% by mass, that effect is diminished, while if the Cu content exceeds 10% by mass, it becomes difficult to obtain stable plating properties, and variations in hardness during hardening treatment become large.

In the connector terminal of the present invention, at least one of the male terminal and the female terminal may be fabricated with a Cu alloy thin plate subjected to Ni—Sn alloy plating treatment containing 0.1-40% by mass of Ni, and in which the remainder is comprised of Sn and unavoidable impurities. Namely, in this connector terminal, since at least one of the male terminal and the female terminal is fabricated with a Cu alloy thin plate subjected to Ni—Sn alloy plating treatment containing 0.1-40% by mass of Ni, and in which the remainder is comprised of Sn and unavoidable impurities, the desired surface hardness is obtained in the plated state. Moreover, extremely high hardness can be obtained by heat treatment. If the Ni content is less than 0.1% by mass, that effect is diminished, while if the Ni content exceeds 40% by mass, it becomes difficult to control hardness.

In the connector terminal of the present invention, at least one of the male terminal and the female terminal may be fabricated with a Cu alloy thin plate subjected to Ag—Sn alloy plating treatment containing 0.1-10% by mass of Ag, and in which the remainder is comprised of Sn and unavoidable impurities. Namely, in this connector terminal, since at least one of the male terminal and the female terminal is fabricated with a Cu alloy thin plate subjected to Ag—Sn alloy plating treatment containing 0.1-10% by mass of Ag, and in which the remainder is comprised of Sn and unavoidable impurities, stable surface hardness can be obtained by hardening treatment. If the Ag content is less than 0.1% by mass, that effect is diminished, while if the Ag content exceeds 10% by mass, together with it becoming difficult to manage the plating liquid, variations in hardness following hardening treatment become large.

In the connector terminal of the present invention, at least one of the male terminal and the female terminal may be fabricated with an Sn-plated Cu alloy thin plate of Sn plating obtained by Sn electroplating, Sn electroplating subjected to reflow treatment or hot dipping either directly or via a Cu layer onto a base material of Cu alloy. Namely, in this connector terminal, since at least one of the male terminal and the female terminal is fabricated with an Sn-plated Cu alloy thin plate of Sn plating obtained by Sn electroplating, Sn electroplating subjected to reflow treatment or hot dipping either directly or via a Cu layer onto a base material of Cu alloy, mutual diffusion occurs between the Sn plating and Cu layer or base material, making it possible to achieve a hard Cu—Sn alloy layer (intermetallic compound layer of Cu and Sn such as Cu₆Sn₅ or Cu₃Sn), and allowing the connector terminal to have a surface of high hardness. The greater the degree to which the Cu—Sn alloy layer is achieved, namely the greater the thickness of the remaining pure Sn layer, the greater the difficulty in obtaining a hard Sn surface. In addition, since the changes in hardness over time of a Cu—Sn alloy layer are smaller than those of a pure Sn layer, changes over time in contact resistance are suppressed.

In the connector terminal of the present invention, the terminal having the harder Vickers hardness may be fabricated with an Sn-plated Cu alloy thin plate in which a pure Sn layer is formed either directly or via a Cu layer on a base material of a Cu alloy, and the pure Sn layer and the base material or the Cu layer are mutually thermally diffused to form a Cu—Sn alloy layer by heat treatment until the thickness of said pure Sn layer becomes less than 0.6 μm. Namely, in this connector terminal, since the terminal having the higher Vickers hardness is fabricated with an Sn-plated Cu alloy thin plate by mutually thermally diffusing the pure Sn layer and the base material or the Cu layer to form a Cu—Sn alloy layer by heat treatment until the thickness of said pure Sn layer becomes less than 0.6 μm, satisfactory low insertion force can be obtained during insertion. If the thickness of the pure Sn layer is 0.6 μm or more, it becomes difficult to obtain low insertion force.

Moreover, in the connector terminal of the present invention, it is preferable that the connector terminal is fabricated with an Sn-plated Cu alloy thin plate in which the Cu—Sn alloy layer is formed by heat treatment until the thickness of the pure Sn layer becomes less than 0.3 μm. Namely, in this connector terminal, since the connector terminal is fabricated with an Sn-plated Cu alloy thin plate in which a Cu—Sn alloy layer is formed by heat treatment until the thickness of the pure Sn layer becomes less than 0.3 μm, even lower insertion force can be obtained.

In the connector terminal of the present invention, it is preferable that the connector terminal is fabricated with an Sn-plated Cu alloy thin plate in which the Cu—Sn alloy layer is formed by heat treatment until the thickness of the pure Sn layer becomes 0. Namely, in this connector terminal, since the connector terminal is fabricated with an Sn-plated Cu alloy thin plate in which a Cu—Sn alloy layer is formed by heat treatment until the thickness of the pure Sn layer becomes 0, low insertion force can be obtained. In addition, since a Cu—Sn alloy layer is formed to the surface, there are hardly any changes over time in contact resistance.

In the connector terminal of the present invention, at least one of the male terminal and the female terminal may be fabricated with an Sn-plated Cu alloy thin plate in which the Cu—Sn alloy layer is formed by reflow treatment of an electroplated Sn-plated bar.

In the connector terminal of the present invention, at least one of the male terminal and the female terminal may be fabricated with an Sn-plated Cu alloy thin plate in which the Cu—Sn alloy layer is formed by pre-annealing an electroplated Sn-plated bar, reflow-treated Sn-plated bar or hot-dipped Sn-plated bar.

In these connector terminals, since one of the terminals is fabricated with an Sn-plated Cu alloy thin plate composed of an Sn-plated bar, they have superior handling ease and volume production ease.

In the connector terminal of the present invention, at least one of the male terminal and the female terminal may be press formed. Namely, in this connector terminal, since at least one of the male terminal and the female terminal is press formed, the desired surface hardness and ease of insertion and removal can be obtained by performing plating hardening treatment after performing severe bending.

In the connector terminal of the present invention, at least one of the male terminal and the female terminal may be subjected to the Sn plating treatment after the press forming. Namely, in this connector terminal, since at least one of the male terminal and the female terminal is treated with Sn plating after press forming, there is less little susceptibility to the occurrence of problems in bending caused by hard plating, and local plating and hardening treatment can be performed on sliding portions and so forth.

### BRIEF DESCRIPTION OF THE DRAWINGS

FIG. 1 is a perspective view showing a male terminal and female terminal in the engaged state in an embodiment of a connector terminal as claimed in the present invention.

FIG. 2 is a cross-sectional view of the essential portion showing a plated Cu alloy thin plate in an embodiment of a connector terminal as claimed in the present invention.

FIG. 3 is a cross-sectional view of the essential portion showing more preferable plated Cu alloy thin plate in an embodiment of a connector terminal as claimed in the present invention.

### BEST MODE FOR CARRYING OUT THE INVENTION

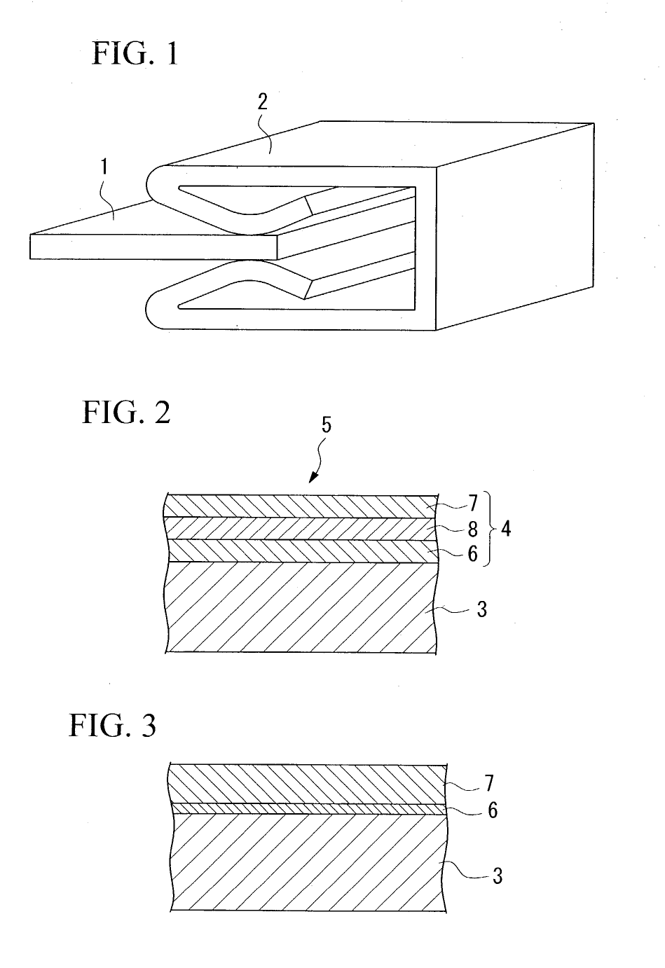

The following provides an explanation of an embodiment of a connector terminal as claimed in the present invention with reference to FIG. 1.

The connector terminal of the present embodiment is, for example, a connector for mounting in an automobile, and as shown in FIG. 1, is composed of at least a pair of mutually engaging male terminal 1 and female terminal 2 fabricated with a plated Cu alloy thin plate.

This male terminal 1 and female terminal 2 are such that, in a mutually sliding portion, the Vickers hardness of male terminal 1 is within the range of 60-700 HV, the Vickers hardness of female terminal 2 is within the range of 20-150 HV, and the difference between the Vickers hardness values of both is set to be 15 HV or more.

Preferably, the Vickers hardness of male terminal 1 is within the range of 80-300 HV, the Vickers hardness of female terminal 2 is within the range of 40-150 HV, and the difference between the Vickers hardness values of both is 20 HV or more. More preferably, the Vickers hardness of male terminal 1 is within the range of 100-250 HV, the Vickers hardness of female terminal 2 is within the range of 40-130 HV, and the difference between the Vickers hardness values of both is 30 HV or more. Even more preferably, the Vickers hardness of male terminal 1 is within the range of 120-250 HV, the Vickers hardness of female terminal 2 is within the range of 40-1 10 HV, and the difference between the Vickers hardness values of both is 50 HV or more.

In addition, as shown in FIG. 2, male terminal 1 and female terminal 2 are fabricated with a metal thin plate 5 in which plating treatment containing one type or two or more types of metals selected from the group consisting of Cu, Ag, Ni, Pb, Zn, P, B, Cr, Mn, Fe, Co, Pd, Pt, Ti, Zr, Hf, V, Nb, Ta, Mo, W, In, C, S, Au, Al, Si, Sb, Bi and Te is performed on the surface of a base material 3 of Cu alloy to form plating layer 4.

The plating treatment is Sn alloy plating treatment in which the remainder other than the selected one type or two or more types of metals is comprised of Sn, and plating layer 4 is Sn alloy or Sn. In addition, the plating layers of male terminal 1 and female terminal 2 are set to contain 0.01-75% by mass of the selected one type or two or more types of metals. In addition, as another example, male terminal 1 and female terminal 2 may be fabricated with a Cu alloy thin plate subjected to Ni—Sn alloy plating treatment containing 0.1-40% by mass of Ni and in which the remainder is comprised of Sn and unavoidable impurities. Moreover, as another example, male terminal 1 and female terminal 2 may be fabricated with a Cu alloy thin plate subjected to Ag—Sn alloy plating treatment containing 0.1-10% by mass of Ag and in which the remainder is comprised of Sn and unavoidable impurities.

In the case where the male terminal 1 and female terminal 2 are fabricated by plating treatment with pure Sn, the terminals 1 and 2 are fabricated with an Sn-plated Cu alloy thin plate which is formed by forming a Cu layer 6 onto a base material 3 of Cu alloy, and by forming a pure Sn layer 7 on the Cu layer 6 using Sn electroplating, Sn electroplating subjected to reflow treatment, or hot dipping. Any of the Sn plating may be performed directly onto Cu alloy base material 3.

In the male terminal 1, a Cu—Sn alloy layer 8 is formed by mutually thermally diffusing pure Sn layer 7 and base material 3 or Sn layer 7 and Cu layer 6 by heat treatment until the thickness of pure Sn layer 7 becomes less than 0.6 μm. Preferably, the thickness of pure Sn layer 7 in male terminal 1 is less than 0.3 μm, and more preferably, as shown in FIG. 3, Cu—Sn alloy layer 8 is formed on the surface by heat treatment until the thickness of pure Sn layer 7 in male terminal 1 becomes 0.

In addition, male terminal 1 and female terminal 2 may also be fabricated with an Sn-plated Cu alloy thin plate in which a Cu—Sn alloy layer 8 has been formed by reflow treatment of an electroplated Sn-plated bar.

Male terminal 1 and female terminal 2 may also be fabricated with an Sn-plated Cu alloy thin plate in which Cu—Sn alloy layer 8 has been formed by pre-annealing an electroplated Sn-plated bar, reflow-treated Sn-plated bar or hot-dipped Sn-plated bar.

Male terminal 1 and female terminal 2 may also have a press-formed base material 3 subjected to any of the plating treatments.

In this manner, in the connector terminal of the present embodiment for carrying out the invention, since, in a sliding portion, the Vickers hardness of male terminal 1 is within the range of 60-700 HV, the Vickers hardness of female terminal 2 is within the range of 20-150 HV, and the difference between the Vickers hardness values of both is 15 HV or more, together with being able to obtain insertion force reduction effects due to low deformation resistance, contact stability is superior and the load during manual insertion and removal is smaller as compared with the case of both terminals having the same degree of hardness.

In addition, since the male terminal 1 and female terminal 2 are fabricated with a metal thin sheet in which the surface of Cu alloy base material 3 has been subjected to plating treatment containing one type or two or more types of metals selected from the metals, the Cu alloy base material and the selected metal are partially formed into an alloy by plating treatment, making it easy to harden the plated surface to a prescribed hardness. By forming an Sn alloy in particular, together with it being easy to control the surface hardness by forming Cu—Sn alloy layer 8 by reacting with the Cu of base material 3, changes over time in contact resistance are suppressed.

The following provides a detailed explanation of the connector terminal as claimed in the present invention according to its embodiments with reference to Tables 1 through 11.

Embodiment 1

Male terminal 1 and female terminal 2 of Embodiment 1 were fabricated in the manner described below.

Copper alloy sheets (base material 3) A and B shown in Table 1 were subjected to alkaline degreasing, electrolytic degreasing and activation treatment, and after forming Cu layer 6 with Cu substrate plating under the following conditions, pure Sn layer 7 was formed by Sn finishing plating to obtain Sn-plated Cu alloy thin plates. Subsequently, the plates were continuously passed through a reducing atmosphere at temperatures of 250° C. and 300° C. for 10-80 seconds to perform reflow treatment and cause the development of Cu—Sn alloy layer 8, and obtain plated Cu alloy thin plates provided with the surface hardening shown in Table 2.

TABLE 1

| | | Composition (wt %) | | Characteristics | | |
|---|---|---|---|---|---|---|
| | | | Cu and | Tensile | | |
| Cu | Thickness | Non-Cu | unavoidable | strength | Elongation | Hardness |
| alloy | (mm) | components | impurities | (N/mm²) | (%) | (Hv) |
| A | 0.64 | Zn: 30.4 | Remainder | 553 | 11 | 180 |
| B | 0.25 | Ni: 1.92, Si: 0.48, | Remainder | 695 | 12 | 213 |
| | | Sn: 0.48, Zn: 0.85 | | | | |
| C | 0.64 | Zn: 29.5 | Remainder | 530 | 14 | 172 |
| D | 0.25 | Zn: 30.8 | Remainder | 536 | 14 | 173 |
| E | 0.64 | Fe: 2.25, Zn: 0.14, | Remainder | 534 | 7 | 152 |
| | | P: 0.025 | | | | |
| F | 0.25 | Mg: 0.67, P: 0.008 | Remainder | 562 | 10 | 181 |
| G | 0.64 | Ni: 1.98, Si: 0.51, | Remainder | 688 | 13 | 211 |
| | | Sn: 0.46, Zn: 0.88 | | | | |
| H | 0.25 | Sn: 6.1, | Remainder | 634 | 11 | 206 |
| | | P: 0.12 | | | | |
| I | 0.32 | Zn: 28.8 | Remainder | — | — | 148 |
| J | 0.3 | Mg: 0.69, P: 0.006 | Remainder | — | — | 173 |
| K | 0.64 | Zn: 30.9 | Remainder | — | — | 150 |
| L | 0.25 | Ni: 1.88, Si: 0.45, | Remainder | — | — | 196 |
| | | Sn: 0.46, Zn: 0.81 | | | | |
| M | 0.64 | Ni: 1.93, Si: 0.47, | Remainder | — | — | 172 |
| | | Sn: 0.51, Zn: 0.92 | | | | |
| N | 0.25 | Ni: 1.90, Si: 0.43, | Remainder | — | — | 203 |
| | | Sn: 0.53, Zn: 0.83 | | | | |

TABLE 2

| | | | | Other terminal material | | | | | | Combined | | |
|---|---|---|---|---|---|---|---|---|---|---|---|---|
| | | | | Reflow | | After reflow | | | | terminals | | |
| | | | | conditions | | Alloy | | Terminal | | Hardness | Insertion | |
| | | Combination | | Temp. | Time | layer | Sn | hardness HV | | difference | force | |
| Classification | No. | Female | Male | (° C.) | (sec) | (μm) | (μm) | Female | Male | ΔHV | (N) | Remarks |
| | | | A(1) | 250 | 80 | 0.96 | 0.65 | | 69 | | | |
| | | B(1) | | 250 | 65 | 1.05 | 0.64 | 74 | | | | |
| Terminals | 1 | B(1) | A(2) | 300 | 45 | 1.3 | 0.48 | 74 | 90 | 16 | 8.6 | |
| of | 2 | B(1) | A(3) | 300 | 50 | 1.46 | 0.4 | 74 | 103 | 29 | 8 | |
| present | 3 | B(1) | A(4) | 300 | 55 | 1.64 | 0.31 | 74 | 111 | 37 | 7.5 | |
| invention | 4 | B(1) | A(5) | 300 | 60 | 1.78 | 0.24 | 74 | 135 | 61 | 7.2 | |
| | 5 | B(1) | A(6) | 300 | 70 | 2.14 | 0.06 | 74 | 198 | 124 | 6.5 | |
| | 6 | B(2) | A(1) | 300 | 40 | 1.41 | 0.47 | 99 | 69 | 30 | 8.8 | |
| | 7 | B(3) | A(1) | 300 | 45 | 1.7 | 0.32 | 114 | 69 | 45 | 8.5 | |
| | 8 | B(4) | A(1) | 300 | 50 | 1.82 | 0.26 | 137 | 69 | 68 | 8.2 | |
| Comparative | 9 | B(1) | A(1) | | | | | 74 | 69 | 5 | 13.6 | Small |
| terminals | | | | | | | | | | | | ΔHV |
| | 10 | B(5) | A(6) | 300 | 60 | 2.18 | 0.08 | 176 | 198 | 22 | 11.1 | HV > |
| | | | | | | | | | | | | 150 |
| | 11 | B(6) | A(1) | 250 | 10 | 0.46 | 0.9 | 58 | 69 | 11 | 11.5 | Small |
| | | | | | | | | | | | | ΔHV, |
| | | | | | | | | | | | | Sn > |
| | | | | | | | | | | | | 0.6 μm |

In Table 2, although the thickness of pure Sn layer 7 and the thickness of Cu—Sn alloy layer 8 were primarily determined by a coulometric film thickness gauge and fluorescent X-ray measurement, these were combined with the use of SEM and EPMA observation, etc. as necessary, and the values were indicated as mean values.

The following indicates the conditions of each of the plating layers.

A) Cu substrate plating conditions (Cu layer 6) plating bath composition: 200 g/l copper sulfate, 55 g/l sulfuric acid, plating bath temperature: 30° C., current density: 2 A/dm²;

B) Sn finishing plating conditions (pure Sn layer 7) plating bath composition: 40 g/l stannous sulfate, 110 g/l sulfuric acid, 25 g/l cresol sulfonate, 7 g/l additive, plating bath temperature: 20° C., current density: 3 A/dm².

Male terminal 1 and female terminal 2 having the shapes shown in FIG. 1 were fabricated using these plated copper alloy thin plates, and the difference between the Vickers hardness values (HV) of both were determined for the respective sliding portions of male terminal 1 and female terminal 2. Those results are shown in Table 2. The maximum load during insertion of male terminal 1 into female terminal 2 was measured ten times each for various combinations, and their mean values were indicated as insertion force (N) for the terminals of the present invention (Nos. 1-8) in Table 2. The measured results for comparative terminals are also shown in Table 2 for those having a difference in Vickers hardness values AHV between the two terminals smaller than the range of the present invention (Nos. 9 and 1 1), and that for which Vickers hardness HV exceeded 150 (No. 10). With respect to comparative terminal no. 11, the thickness of pure Sn layer 7 exceeded 0.6 μm.

In this manner, insertion force that was lower than the comparative terminals was able to be obtained with the present invention as shown in the results of Table 2.

Embodiment 2

Male terminal 1 and female terminal 2 of Embodiment 2 were fabricated in the manner described below.

Annealing was performed at 200-220° C. for 30-10000 seconds, respectively, on electrolytic Sn-plated Cu alloy thin plates C and D, reflow Sn-plated Cu alloy thin plates E and F, and hot-dip Sn-plated Cu alloy thin plates G and H to cause the development of Cu—Sn alloy layer 8 and perform hardening treatment. The thickness of pure Sn layer 7 and the thickness of Cu—Sn alloy layer 8 were measured following hardening treatment as shown in Table 3.

TABLE 3

| | | | | Other terminal material | | | | | | | | |
|---|---|---|---|---|---|---|---|---|---|---|---|---|
| | | | | | | After | | | | | | |
| | | | | Hardening | | hardening | | | | Combined | | |
| | | | | treatment | | treatment | | | | terminals | | |
| | | | | conditions | | Alloy | | Terminal | | Hardness | Insertion | |
| | | Combination | | Temp. | Time | layer | Sn | hardness HV | | difference | force | |
| Classification | No. | Female | Male | (° C.) | (sec) | (μm) | (μm) | Female | Male | ΔHV | (N) | Remarks |
| | | | C(1) | Electrolytic Sn | | 0.15 | 0.96 | | 65 | | | |
| | | | | plating | | | | | | | | |
| | | D(1) | | Electrolytic Sn | | 0.12 | 1.12 | 61 | | | | |
| | | | | plating | | | | | | | | |
| | | | E(1) | Reflow Sn | | 1.02 | 0.87 | | 73 | | | |
| | | | | plating | | | | | | | | |
| | | F(1) | | Reflow Sn | | 0.94 | 0.67 | 86 | | | | |
| | | | | plating | | | | | | | | |
| | | | G(1) | Hot-dip Sn | | 1.72 | 1.63 | | 47 | | | |
| | | | | plating | | | | | | | | |
| | | H(1) | | Hot-dip Sn | | 1.44 | 1.9 | 33 | | | | |
| | | | | plating | | | | | | | | |
| Terminals | 21 | D(1) | C(2) | 200 | 1800 | 1.11 | 0.48 | 61 | 92 | 31 | 8.3 | |
| of | 22 | D(1) | C(3) | 200 | 5000 | 1.65 | 0.21 | 61 | 145 | 84 | 7.1 | |
| present | 23 | D(1) | C(4) | 210 | 10000 | 1.97 | 0.05 | 61 | 240 | 179 | 6.4 | |
| invention | 24 | D(1) | C(5) | 220 | 10000 | 2.07 | >0 | 61 | 370 | 309 | 5.7 | |
| | 25 | F(1) | E(2) | 210 | 1800 | 1.84 | 0.46 | 86 | 102 | 16 | 8.5 | |
| | 26 | F(1) | E(3) | 210 | 2500 | 2.16 | 0.3 | 86 | 112 | 26 | 8.3 | |
| | 27 | F(1) | E(4) | 210 | 5000 | 2.6 | 0.08 | 86 | 195 | 109 | 6.8 | |
| | 28 | F(2) | E(1) | 210 | 2000 | 1.86 | 0.21 | 122 | 73 | 49 | 8.5 | |
| | 29 | F(1) | C(3) | | | | | 86 | 145 | 59 | 7.3 | |
| | 30 | H(1) | G(2) | 215 | 600 | 4.2 | 0.39 | 33 | 108 | 75 | 7.7 | |
| | 31 | H(1) | G(3) | 215 | 5000 | 5 | >0 | 33 | 310 | 277 | 6.5 | |
| | 32 | H(1) | C(3) | | | | | 33 | 145 | 112 | 7.1 | |
| | 33 | H(1) | E(4) | | | | | 33 | 195 | 162 | 6.8 | |
| Comparative | 34 | D(1) | C(1) | | | | | 61 | 65 | 4 | 13.1 | Small |
| terminals | | | | | | | | | | | | ΔHV, |
| | | | | | | | | | | | | Sn > |
| | | | | | | | | | | | | 0.6 μm |
| | 35 | F(1) | E(1) | | | | | 86 | 73 | 13 | 13 | Small |
| | | | | | | | | | | | | ΔHV, |
| | | | | | | | | | | | | Sn > |
| | | | | | | | | | | | | 0.6 μm |
| | 36 | F(2) | E(3) | | | | | 122 | 112 | 10 | 12.1 | Small |
| | | | | | | | | | | | | ΔHV |
| | 37 | H(1) | G(1) | | | | | 33 | 47 | 14 | 14.7 | Small |
| | | | | | | | | | | | | ΔHV, |
| | | | | | | | | | | | | HV < 60 |
| | 38 | H(2) | E(4) | 215 | 3600 | 4.9 | 0.15 | 170 | 195 | 25 | 10.6 | HV > 150 |

Male terminal 1 and female terminal 2 having the shapes shown in FIG. 1 were fabricated using these plated Cu alloy thin plates, and the difference between the Vickers hardness values (HV) of both were determined for the respective sliding portions of male terminal 1 and female terminal 2. Those results are shown in Table 3. The maximum load during insertion of male terminal 1 into female terminal 2 was measured ten times each for various combinations, and their mean values were indicated as insertion force (N) for the terminals of the present invention (Nos. 21-33) in Table 3. The measured results for comparative terminals are also shown in Table 3 for those having a difference in Vickers hardness values AHV between the two terminals smaller than the range of the present invention (Nos. 34-37), and that for which Vickers hardness HV exceeded 150 (No. 38). With respect to comparative terminal nos. 34 and 35, the thickness of pure Sn layer 7 exceeded 0.6 μm, and with respect to comparative terminal no. 37, the Vickers hardness was less than 60.

In this manner, insertion force that was lower than the comparative terminals was able to be obtained with the present invention as shown in the results of Table 3.

Embodiment 3

Male terminal 1 and female terminal 2 of Embodiment 3 were fabricated in the manner described below.

Insertion force and removal force were measured for terminals press formed from Sn-plated Cu alloy thin plates after respectively annealing at a temperature of 150-700° C. for 1-600 minutes. The composition and hardness of the Cu alloys of the terminal materials used for evaluation (I-N of Table 1) are shown in Table 1. Evaluations were performed by selecting three models of engaging terminals consisting of model 090 (male terminal width of 2.3 mm), model 040 (male terminal width of 1.0 mm) and model 025 (male terminal width of 0.63 mm). The thickness of pure Sn layer 7 and the thickness of Cu—Sn alloy layer 8 after hardening treatment were measured for each terminal, and the hardness values (HV) of the terminal sliding portions were determined. These evaluations along with an evaluation of the difference in hardness, insertion force and removal force of each pair of male and female terminals are shown in Tables 4-6 for terminals of the present invention, and in Tables 7-9 for comparative terminals outside the range of conditions of the present invention. Each type of combination of terminals was measured 10 times, and insertion force and removal force were indicated with their mean values.

In this manner, insertion force that was lower than the comparative terminals was able to be obtained with the present invention as shown in the results of Tables 4-9.

TABLE 4

| | | | | | | Plating | | | | | |
|---|---|---|---|---|---|---|---|---|---|---|---|
| | | | | Hardening | | layer | | | | | |
| | | | | treatment | | thickness | | | Combined terminals | | |
| Type of engaging | | | Material | conditions | | (μm) | | Terminal | Hardness | Insertion | Removal |
| terminals | | | thickness | Temp. | Time | Alloy | Pure | hardness | difference | force | force |
| Model | Type | Code | (mm) | (° C.) | (min) | layer | Sn | HV | ΔHV | (N) | (N) |
| 090 | M | I | 0.32 | 400 | 1 | 1.40 | 0.18 | 180 | 120 | 4.2 | 4.5 |
| | F | J | 0.30 | None | | 0.68 | 0.75 | 60 | | | |
| | M | I | 0.32 | 300 | 5 | 1.45 | 0.13 | 230 | 170 | 3.8 | 3.4 |

| | | | | | | | | | |
|---|---|---|---|---|---|---|---|---|---|
| F | J | 0.30 | None | 0.68 | 0.75 | 60 | | | |
| M | I | 0.32 | None | 0.82 | 0.55 | 70 | 128 | 5.0 | 4.5 |

| | | | | | | | |
|---|---|---|---|---|---|---|---|
| F | J | 0.30 | 180 | 600 | 1.43 | 0.28 | 198 |

| | | | | | | | | | |
|---|---|---|---|---|---|---|---|---|---|
| M | I | 0.32 | None | 0.82 | 0.55 | 70 | 140 | 4.5 | 4.3 |

| | | | | | | | |
|---|---|---|---|---|---|---|---|
| F | J | 0.30 | 600 | 0.25 | 1.47 | 0.13 | 240 |

TABLE 5

| | | | | | | Plating | | | | | |
|---|---|---|---|---|---|---|---|---|---|---|---|
| | | | | Hardening | | layer | | | | | |
| | | | | treatment | | thickness | | | Combined terminals | | |
| Type of engaging | | | Material | conditions | | (μm) | | Terminal | Hardness | Insertion | Removal |
| terminals | | | thickness | Temp. | Time | Alloy | Pure | hardness | difference | force | force |
| Model | Type | Code | (mm) | (° C.) | (min) | layer | Sn | HV | ΔHV | (N) | (N) |
| 040 | M | K | 0.64 | 500 | 0.5 | 1.60 | 0.17 | 225 | 162 | 1.6 | 1.5 |
| | F | L | 0.25 | None | | 0.83 | 0.65 | 63 | | | |
| | M | K | 0.64 | 600 | 0.25 | 1.55 | 0.19 | 202 | 139 | 2.2 | 1.8 |

| | | | | | | | | | |
|---|---|---|---|---|---|---|---|---|---|
| F | L | 0.25 | None | 0.83 | 0.65 | 63 | | | |
| M | K | 0.64 | None | 0.75 | 0.83 | 56 | 89 | 2.8 | 2.5 |

| | | | | | | | |
|---|---|---|---|---|---|---|---|
| F | L | 0.25 | 250 | 3 | 1.65 | 0.24 | 145 |

TABLE 6

| | | | | | | Plating | | | | | |
|---|---|---|---|---|---|---|---|---|---|---|---|
| | | | | Hardening | | layer | | | | | |
| | | | | treatment | | thickness | | | Combined terminals | | |
| Type of engaging | | | Material | conditions | | (μm) | | Terminal | Hardness | Insertion | Removal |
| terminals | | | thickness | Temp. | Time | Alloy | Pure | hardness | difference | force | force |
| Model | Type | Code | (mm) | (° C.) | (min) | layer | Sn | HV | ΔHV | (N) | (N) |
| 025 | M | M | 0.64 | 350 | 10 | 1.61 | 0.09 | 245 | 175 | 0.5 | 0.5 |

| | | | | | | | | | |
|---|---|---|---|---|---|---|---|---|---|
| F | N | 0.25 | None | 0.76 | 0.53 | 70 | | | |
| M | M | 0.64 | None | 0.78 | 0.63 | 65 | 230 | 0.65 | 0.65 |

| | | | | | | | |
|---|---|---|---|---|---|---|---|
| F | N | 0.25 | 650 | 1 | 1.63 | 0.06 | 295 |

TABLE 7

| | | | | | | Plating | | | | | |
|---|---|---|---|---|---|---|---|---|---|---|---|
| | | | | Hardening | | layer | | | | | |
| | | | | treatment | | thickness | | | Combined terminals | | |
| Type of engaging | | | Material | conditions | | (μm) | | Terminal | Hardness | Insertion | Removal |
| terminals | | | thickness | Temp. | Time | Alloy | Pure | hardness | difference | force | force |
| Model | Type | Code | (mm) | (° C.) | (min) | layer | Sn | HV | ΔHV | (N) | (N) |
| 090 | M | I | 0.32 | None | | 0.82 | 0.55 | 70 | 10 | 7.1 | 6.5 |
| | F | J | 0.30 | None | | 0.68 | 0.75 | 60 | | | |
| | M | I | 0.32 | 500 | 0.5 | 1.35 | 0.20 | 185 | 10 | 8.7 | 8.9 |
| | F | J | 0.30 | 550 | 0.5 | 1.27 | 0.28 | 175 | | | |
| | M | I | 0.32 | 150 | 30 | 0.85 | 0.51 | 72 | 12 | 7.1 | 6.3 |

| | | | | | | |
|---|---|---|---|---|---|---|
| F | J | 0.30 | None | 0.68 | 0.75 | 60 |

TABLE 8

| | | | | | | Plating | | | | | |
|---|---|---|---|---|---|---|---|---|---|---|---|
| | | | | Hardening | | layer | | | | | |
| | | | | treatment | | thickness | | | Combined terminals | | |
| Type of engaging | | | Material | conditions | | (μm) | | Terminal | Hardness | Insertion | Removal |
| terminals | | | thickness | Temp. | Time | Alloy | Pure | hardness | difference | force | force |
| Model | Type | Code | (mm) | (° C.) | (min) | layer | Sn | HV | ΔHV | (N) | (N) |
| 040 | M | K | 0.64 | None | | 0.75 | 0.83 | 56 | 7 | 3.5 | 4.0 |
| | F | L | 0.25 | None | | 0.83 | 0.65 | 63 | | | |
| | M | K | 0.64 | 150 | 30 | 0.85 | 0.65 | 75 | 12 | 3.3 | 3.9 |
| | F | L | 0.25 | None | | 0.83 | 0.65 | 63 | | | |
| | M | K | 0.64 | 280 | 45 | 1.86 | 0.06 | 280 | 10 | 4.5 | 4.6 |
| | F | L | 0.25 | 280 | 300 | 1.85 | 0.03 | 290 | | | |

TABLE 9

| | | | | | | Plating | | | | | |
|---|---|---|---|---|---|---|---|---|---|---|---|
| | | | | Hardening | | layer | | | | | |
| | | | | treatment | | thickness | | | Combined terminals | | |
| Type of engaging | | | Material | conditions | | (μm) | | Terminal | Hardness | Insertion | Removal |
| terminals | | | thickness | Temp. | Time | Alloy | Pure | hardness | difference | force | force |
| Model | Type | Code | (mm) | (° C.) | (min) | layer | Sn | HV | ΔHV | (N) | (N) |
| 025 | M | M | 0.64 | None | | 0.78 | 0.63 | 65 | 5 | 1.0 | 1.2 |
| | F | N | 0.25 | None | | 0.76 | 0.53 | 70 | | | |
| | M | M | 0.64 | 200 | 10 | 0.98 | 0.52 | 79 | 2 | 1.1 | 1.1 |
| | F | N | 0.25 | 180 | 30 | 0.99 | 0.40 | 81 | | | |
| | M | M | 0.64 | 700 | 0.1 | 1.57 | 0.10 | 195 | 10 | 1.4 | 1.6 |
| | F | N | 0.25 | 200 | 300 | 1.46 | 0.09 | 205 | | | |

Embodiment 4

Male terminal 1 and female terminal 2 of Embodiment 4 were fabricated in the manner described below.

Copper alloy sheets A and B shown in Table 1 were subjected to alkaline degreasing, electrolytic degreasing and activation treatment, and after performing bi-layer plating with Ni plating and Cu plating, or Cu plating, to serve as the substrate plating, finishing plating was performed with Ni plating, Ag plating, Sn—Cu plating, Sn—Ni plating or Sn-Ag plating. The corresponding plating conditions were as shown in Embodiment 1 and Table 10.

Plating Conditions of Embodiment 4

[Ni Plating Conditions]

Plating bath composition: 240 g/l nickel sulfate, 45 g/l nickel chloride, 30 g/l boric acid; plating bath temperature: 35° C.; current density: 2 A/dm²

[Sn-2% Cu Alloy Plating Conditions]

Plating bath composition: 50 g/l stannous sulfate, 45 g/l sulfuric acid, 1 g/l Top Fleet SC-S (trade mark of Okuno Chemical Industries Co., Ltd.), 10 ml/l Top Fleet SC-R, 0.3 ml/l Top Fleet SC-1; plating bath temperature: 20° C.; current density: 2 A/dm²

[Sn- 19% Ni Alloy Plating Conditions]

Plating bath composition: 500 ml/l Pyroalloy SN Starter (trade mark of Nihon Kagaku Sangyo Co., Ltd.), 20 ml/l Pyroalloy SN Makeup, 25 g/l tin pyrophosphate; plating bath temperature: 40° C.; current density: 1 A/dm²

[Sn-26% Ni Alloy Plating Conditions]

Plating bath composition: 500 ml/l Pyroalloy SN Starter, 20 ml/l Pyroalloy SN Makeup; plating bath temperature: 40° C.; current density: 1 A/dm²

[Ag Plating Conditions]

Plating bath composition: 10 g/l silver cyanide, 20 g/l potassium cyanide, 10 g/l potassium carbonate; plating bath temperature: 25° C.; current density: 2 A/dm²

[Sn-2% Ag Alloy Plating Conditions]

Plating bath composition: 1000 ml/l UTB TS-140 BASE (trade mark of Ishihara Chemical Co., Ltd.), 2 g/l TS-AG additive (trade mark of Ishihara Chemical Co., Ltd.); plating bath temperature: 25° C.; current density: 2 A/dm²

The thicknesses of the Cu substrate plating, Ni plating, alloy layer and surface layer plating of the resulting plated Cu alloy thin plates of the present invention and comparative plated Cu alloy thin plates were primarily determined by fluorescent X-ray measurement and a coulometric film thickness gauge, and were supplemented by combining with the use of observations of the cross-sections by SEM and EPMA to obtain the final thicknesses.

Male terminal 1 and female terminal 2 having the shapes shown in FIG. 1 were fabricated using these plated Cu alloy thin plates, and the Vickers hardness (HV), along with the difference in their Vickers hardness values AHV, were determined for the respective sliding portions of the male and female terminals, the results of which are shown in Table 11. In Table 11, the maximum load during insertion of male terminal 1 into female terminal 2 was measured ten times each for various combinations, and their mean values were indicated as insertion force (N) for the terminals of the present invention (Nos. 1-10) in Table 11. The measured results for comparative terminals are also shown in Table 11 for those having a difference in Vickers hardness values AHV between the two terminals smaller than the range of the present invention (Nos. 1-5). The Vickers hardness (HV) of comparative terminal no. 1 exceeds 150.

In this manner, insertion force that was lower than the comparative terminals was able to be obtained with the present invention as shown in the results of Table 11.

TABLE 11

| | | Type of | | | Hardening | | | | | | | | | |
|---|---|---|---|---|---|---|---|---|---|---|---|---|---|---|
| | | Engaging | | Material | treatment | | Plated layer thickness (μm) | | | | Terminal | Comb. terminals | | |
| | | Terminals | | thickness | Temp. | Time | Cu | Ni | Alloy | Surface | hardness | Hardness | Insertion | |
| Class | No. | Type | Code | (mm) | (° C.) | (sec) | sub. | sub. | layer | layer | HV | diff. ΔHV | force (N) | Remarks |
| Terminals | 1 | M | A | 0.64 | — | | 0.43 | | 0.12 | Ni, 0.75 | 259 | 185 | 5.6 | |
| of present | | F | B | 0.25 | 250 | 65 | | | 1.05 | Sn, 0.64 | 74 | | | |
| invention | 2 | M | A | 0.64 | — | — | 0.43 | | 0.12 | Ni, 0.75 | 259 | 155 | 5.8 | |
| | | F | B | 0.25 | — | — | 0.35 | | 0.15 | Sn—Ni, 0.48 | 104 | | | Sn—19% Ni |
| | 3 | M | A | 0.64 | 280 | 60 | | 0.22 | 0.38 | Ag, 0.21 | 143 | 68 | 6.8 | |
| | | F | B | 0.25 | — | — | | 0.29 | 0.07 | Ag, 0.52 | 77 | | | |
| | 4 | M | A | 0.64 | — | — | 0.45 | | 0.18 | Sn—Cu, | 69 | 121 | 6.3 | Sn—2% Cu |
| | | | | | | | | | | 0.48 | | | | |
| | | F | B | 0.25 | 280 | 75 | 0.20 | | 0.48 | Sn—Cu, | 190 | | | Sn—2% Cu |
| | | | | | | | | | | 0.23 | | | | |
| | 5 | M | A | 0.64 | 300 | 55 | — | | 1.64 | Sn, 0.31 | 111 | 79 | 6.7 | |
| | | F | B | 0.25 | 280 | 75 | 0.20 | | 0.48 | Sn—Cu, | 190 | | | Sn—2% Cu |
| | | | | | | | | | | 0.23 | | | | |
| | 6 | M | A | 0.64 | 280 | 75 | 0.12 | | 0.68 | Sn—Ni, 0.22 | 222 | 118 | 6.6 | Sn—19% Ni |
| | | F | B | 0.25 | — | — | 0.35 | | 0.15 | Sn—Ni, 0.48 | 104 | | | Sn—19% Ni |
| | 7 | M | A | 0.64 | 280 | 75 | 0.12 | | 0.68 | Sn—Ni, 0.22 | 222 | 133 | 5.8 | Sn—19% Ni |
| | | F | B | 0.25 | 300 | 35 | 0.10 | 0.20 | 0.40 | Sn, 0.43 | 89 | | | |
| | 8 | M | A | 0.64 | 350 | 300 | — | | 1.43 | Sn—Ni, — | 690 | 599 | 5.3 | Sn—2.6% Ni |
| | | F | B | 0.25 | — | — | 0.35 | | 0.15 | Sn—Ni, 0.48 | 104 | | | Sn—19% Ni |
| | 9 | M | A | 0.64 | 280 | 90 | 0.20 | | 0.75 | Sn—Ag, | 118 | 45 | 7.2 | Sn—2% Ag |
| | | | | | | | | | | 0.37 | | | | |
| | | F | B | 0.25 | — | — | 0.39 | | 0.12 | Sn—Ag, | 73 | | | Sn—2% Ag |
| | | | | | | | | | | 0.88 | | | | |
| | 10 | M | A | 0.64 | 280 | 120 | 0.05 | | 1.12 | Sn—Ag, | 138 | 31 | 7.4 | Sn—2% Ag |
| | | | | | | | | | | 0.21 | | | | |
| | | F | B | 0.25 | 280 | 75 | 0.11 | | 0.69 | Sn—Ag, | 107 | | | Sn—2% Ag |
| | | | | | | | | | | 0.53 | | | | |
| Compar- | 1 | M | A | 0.64 | — | — | 0.43 | | 0.12 | Ni, 0.75 | 259 | 8 | 12.2 | Small ΔHV, |
| ative | | F | B | 0.25 | — | — | 0.41 | | 0.10 | Ni, 0.45 | 251 | | | HV > 150 |
| terminals | 2 | M | A | 0.64 | — | — | | 0.31 | 0.12 | Ag, 0.47 | 86 | 9 | 12.7 | Small |
| | | F | B | 0.25 | — | — | | 0.29 | 0.07 | Ag, 0.52 | 77 | | | ΔHV |
| | 3 | M | A | 0.64 | — | — | 0.45 | | 0.18 | Sn—Cu, | 69 | 5 | 12.9 | Sn—2% Cu |
| | | | | | | | | | | 0.48 | | | | |
| | | F | B | 0.25 | 250 | 65 | | | 1.05 | Sn, 0.64 | 74 | | | Small ΔHV |
| | 4 | M | A | 0.64 | — | — | 0.41 | | 0.10 | Sn—Ni, 0.51 | 106 | 2 | 13.1 | Sn—19% Ni |
| | | F | B | 0.25 | — | — | 0.35 | | 0.15 | Sn—Ni, 0.48 | 104 | | | SmallΔHV |
| | 5 | M | A | 0.64 | 280 | 90 | 0.20 | | 0.75 | Sn—Ag, | 118 | 11 | 11.8 | Sn—2% Ag |
| | | | | | | | | | | 0.37 | | | | |
| | | F | B | 0.25 | 280 | 75 | 0.11 | | 0.69 | Sn—Ag, | 107 | | | SmallΔHV |
| | | | | | | | | | | 0.53 | | | | |

The scope of the present invention is not limited by the embodiments, and various modifications can be added within a range that does not deviate from the gist of the present invention.

For example, the present invention is not limited by the conditions of reflow treatment or following annealing (aging) conditions. For example, the reflow temperature of Sn plating and Sn alloy plating can be within a range of 230-1000° C., and the time can be within the range of 1 second to 10 hours. In addition, the treatment atmosphere may be air, a reducing environment such as H₂ or CO, or an inert atmosphere such as N₂ or Ar.

In addition, the present invention is not limited by the composition of the underlayer. For example, the underlayer may include, but is not limited to, Cu underlayer, Ni underlayer, Ni underlayer followed by Cu underlayer, Sn underlayer, and Ag underlayer plating.

In addition, the present invention is basically not limited by the total plating thickness. However, in the case of Sn plating and so forth for example, in the case the total thickness of the Sn plating is 0.3 μm or less, caution is required with respect to corrosion resistance and heat resistance, etc.

In addition, the annealing atmosphere in the mode for carrying out the invention and the embodiments may be air, a reducing atmosphere such as H₂ or CO, an inert atmosphere such as N₂ or Ar, or vacuum annealing treatment.

The presence of a difference in hardness between both male and female terminals as in the present invention is also preferable from the viewpoint of long-term contact stability in environments subjected to high temperatures and vibrations.

In addition, in the case both terminals are comparatively soft, there is increased susceptibility to the incorporation of oxidation products and foreign objects, etc. due to vibrations and so forth, thereby making this undesirable from the viewpoint of long-term contact stability.

In addition, in the case both terminals are comparatively hard, there is increased susceptibility to the occurrence of momentary decreases in the contact surface area of the two terminals due to vibrations and so forth, thereby making this also undesirable from the viewpoint of long-term contact stability.

In the case of being subjected to environments having severe levels of temperature and vibrations in particular, as the difference between the hardness values of both terminals ΔHV increases to 15 or more, 20 or more, 30 or more, and 50 or more, the present invention becomes increasingly preferable from the viewpoint of long-term contact stability.

The following effects are offered by the present invention.

Namely, according to the connector terminal of the present invention, in a mutually sliding portion, since the Vickers hardness of one terminal is within the range of 60-700 HV, the Vickers hardness of the other terminal is 20-150 HV, and the difference between the Vickers hardness values of both terminals is 15 HV or more, together with obtaining the effect of reducing insertion force, the present invention offers superior contact stability, the load during manual insertion and removal is lower, and both work efficiency and quality can be improved as compared with the case of both terminals having about the same hardness.

What is claimed is:

1. A connector terminal comprising a plated Cu alloy thin plate and provided with a pair of mutually engaging male and female terminals; wherein, in a mutually sliding portion of the male terminal and the female terminal, the Vickers hardness of one of the terminals is within the range of 60-700 HV, the Vickers hardness of the other terminal is within the range of 20-150 HV, and the difference between the Vickers hardness values of both is 15 HV or more.

2. The connector terminal according to claim 1 wherein, in a mutually sliding portion of the male terminal and the female terminal, the Vickers hardness of one of the terminals is within the range of 80-300 HV, the Vickers hardness of the other terminal is within the range of 40-150 HV, and the difference between the Vickers hardness values of both is 20 HV or more.

3. The connector terminal according to claim 1 wherein, in a mutually sliding portion of the male terminal and the female terminal, the Vickers hardness of one of the terminals is within the range of 100-250 HV, the Vickers hardness of the other terminal is within the range of 40-130 HV, and the difference between the Vickers hardness values of both is 30 HV or more.

4. The connector terminal according to claim 1 wherein, in a mutually sliding portion of the male terminal and the female terminal, the Vickers hardness of one of the terminals is within the range of 120-250 HV, the Vickers hardness of the other terminal is within the range of 40-110 HV, and the difference between the Vickers hardness values of both is 50 HV or more.

5. The connector terminal according to claim 1 wherein, the terminal having the higher Vickers hardness is the male terminal, while the terminal having the lower Vickers hardness is the female terminal.

6. The connector terminal according to claim 1 wherein, at least one of the male terminal and the female terminal is fabricated with a metal thin plate in which the surface of a base material of a Cu alloy is subjected to plating treatment containing one type or two or more types of metals selected from the group consisting of Sn, Cu, Ag, Ni, Pb, Zn, P, B; Cr, Mn, Fe, Co, Pd, Pt, Ti, Zr, Hf, V, Nb, Ta, Mo, W, In, C, S, Au, Al, Si, Sb, Bi and Te.

7. The connector terminal according to claim 6 wherein, the plating treatment is Sn alloy plating treatment in which the remainder other than the selected one type or two or more types of metals is comprised of Sn.

8. The connector terminal according to claim 7 wherein, at least one of the male terminal and the female terminal contains 0.01-75% by mass of the selected one type or two or more types of metals.

9. The connector terminal according to claim 8 wherein, at least one of the male terminal and the female terminal is fabricated with a Cu alloy thin plate subjected to Cu—Sn alloy plating treatment containing 0.1-10% by mass of Cu and in which the remainder is comprised of Sn and unavoidable impurities.

10. The connector terminal according to claim 8 wherein, at least one of the male terminal and the female terminal is fabricated with a Cu alloy thin plate subjected to Ni—Sn alloy plating treatment containing 0.1-40% by mass of Ni, and in which the remainder is comprised of Sn and unavoidable impurities.

11. The connector terminal according to claim 8 wherein, at least one of the male terminal and the female terminal is fabricated with a Cu alloy thin plate subjected to Ag—Sn alloy plating treatment containing 0.1-10% by mass of Ag, and in which the remainder is comprised of Sn and unavoidable impurities.

12. The connector terminal according to claim 1 wherein, at least one of the male terminal and the female terminal is fabricated with an Sn-plated Cu alloy thin plate of Sn plating obtained by Sn electroplating, Sn electroplating subjected to reflow treatment or hot dipping either directly or via a Cu layer onto a base material of Cu alloy.

13. The connector terminal according to claim 1 wherein, the terminal having the harder Vickers hardness is fabricated with an Sn-plated Cu alloy thin plate in which a pure Sn layer is formed either directly or via a Cu layer on a base material of a Cu alloy, and the pure Sn layer and the base material or the Cu layer are mutually thermally diffused to form a Cu—Sn alloy layer by heat treatment until the thickness of said pure Sn layer becomes less than 0.6 μm.

14. The connecter terminal according to claim 13 wherein, said connector terminal is fabricated with an Sn-plated Cu alloy thin plate in which the Cu—Sn alloy layer is formed by heat treatment until the thickness of the pure Sn layer becomes less than 0.3 μm.

15. The connector terminal according to claim 13 wherein, said connector terminal is fabricated with an Sn-plated Cu alloy thin plate in which the Cu—Sn alloy layer is formed by heat treatment until the thickness of the pure Sn layer becomes 0.

16. The connector terminal according to claim 13 wherein, at least one of the male terminal and the female terminal is fabricated with an Sn-plated Cu alloy thin plate in which the Cu—Sn alloy layer is formed by reflow treatment of an electroplated Sn-plated bar.

17. The connector terminal according to claim 13 wherein, at least one of the male terminal and the female terminal is fabricated with an Sn-plated Cu alloy thin plate in which the Cu—Sn alloy layer is formed by pre-annealing an electroplated Sn-plated bar, reflow-treated Sn-plated bar or hot-dipped Sn-plated bar.

18. The connector terminal according to claim 6 wherein, at least one of the male terminal and the female terminal is press formed.

19. The connector terminal according to claim 18 wherein, at least one of the male terminal and the female terminal is subjected to the plating treatment after the press forming.
